(19) United States
(12) Patent Application Publication
(10) Pub. No.: US 2009/0304473 A1
(43) Pub. Date: Dec. 10, 2009

(54) Method for the milling of blisks

(76) Inventors: Liane HOLZE, Neu-Anspach (DE); Gregor RIEDEL, Buedingen (DE)

Correspondence Address: Harbin Klima Law Group PLLC, 500 Ninth Street SE, Washington, DC, 20003, US

(21) Appl. No.: 12/385,712

(22) Filed: Apr. 16, 2009

(30) Foreign Application Priority Data
Apr. 16, 2008 (DE) 10 2008 019 332.1

(51) Int. Cl. B23C 3/18

(52) U.S. Cl. 409/131

(57) ABSTRACT

When milling blisk blades (13) on a disk blank, side faces of the blades are finish milled and machined by flank milling. Cutting strips (8) of equal width are produced, whose orientation agrees with a flow direction between the blisk blades, such that aerodynamic losses at suction and pressure sides of the blades can be reduced.

This application claims priority to German Patent Application DE102008019332.1 filed Apr. 16, 2008, the entirety of which is incorporated by reference herein.

This invention relates to a method for milling blisks for gas-turbine engines, where at the periphery of a disk blank a multitude of integrally provided blisk blades is pre-shaped by rough milling and subsequently finish machined by finish milling of the pressure and suction side as well as of the annulus.

For the compressors of gas-turbine engines, as is generally known, blisks are also used, on which the rotor blades are integrally connected with the rotor disk to form a one-piece unit. Compared with rotor wheels with conventional blading, on which separately manufactured rotor blades are retained in a dovetail-shaped groove on the periphery of the rotor disk, integrally bladed rotors are characterized, besides reduced assembly costs, by less weight and reduced centrifugal loading of the supporting disk, enabling a multitude of blades to be arranged and, finally, aerodynamic efficiency to be increased.

Blisks are manufactured either by connecting separately produced blade elements to a supporting disk by friction welding, or by milling the blade contours from the solid material, starting at the periphery of a disk blank.

The rotor blades have a complex, three-dimensional shape in that they typically twist around a radial axis, taper from the blade root towards the blade tip, have a concave pressure side and a convex suction side and their blade tip is not parallel to the blade root. Cutting and machining of these blades from the solid material are usually accomplished by point-contact milling using a cutter with semi-spherical cutting head. While a channel is first produced in a rough milling operation, the pressure side and the suction side and, finally, the annulus are finish machined in a subsequent finish milling operation. Rough milling of the channel and subsequent finish milling of the side walls can also be performed sectionally in alternation, actually until the annulus is reached and can be finished. The term “annulus” hereinafter also refers to the transition area between the side faces of the blade and the annulus.

The above mentioned point-contact finishing process for shaping the side faces of the rotor blades, which, for example, is described in Specification U.S. Pat. No. 6,077,002 A, is disadvantageous in that it is time-consuming and with the long operating times and the correspondingly high tool consumption entails high tool and manufacturing costs. Due to the wear of the cutter by the long operating times during finish milling the side faces, dimensional accuracy of the blades, whose thickness increases with increasing tool operating time and corresponding tool wear, is not ensured.

A less time-consuming method for finish milling the side faces of the three-dimensionally shaped blisks is five-axis flank milling, in which a shank-type cutter, whose tool axis is routed parallelly to the blade surfaces, is used to cut areal strips along the suction side and the pressure side parallelly to the root of the blade. Flank milling enables tool wear and tool costs to be reduced and both the dimensional accuracy of the individual blades and the surface finish thereof to be improved. Nevertheless, disadvantageous aerodynamic losses are also encountered on the suction and pressure side of blisk blades whose surface finish is produced by flank milling.

A broad aspect of the present invention is to provide a method for the milling of blisks, which allows a reduction of the aerodynamic losses.

When milling three-dimensionally shaped blisk blades from the solid material of a disk blank, the side faces of the blisk blades, upon being pre-shaped by rough milling, are finished by flank milling and thereby brought to final size. The direction of movement of the cutter, or the course of the cutting strips produced in flank milling, agrees with the direction of flow of the gases at the pressure side and the suction side of the blisk blades in operation of the engine, thereby enabling aerodynamic losses at the blade surfaces to be reduced.

According to a first process variant, the—equally wide—cutting strips which the cutting edge of a cutting tool produces at the blade tip and at the annulus (transition area to the annulus) extend parallelly to these, with a length difference between the blade leading edge and the blade trailing edge due to the oblique alignment of the blade tip and the annulus, i.e. a change in blade length and an inclination between blade tip and annulus, being compensated by overlapping the cutting strips in a fan-like manner. Overlapping milling also reduces the height of the steps between the cutting strips, thereby further improving the flow conditions at the blade surfaces and reducing the polishing effort for the blades.

According to yet another characteristic of the present invention, cutting paths starting at the blade tip and the annulus and extending parallelly to these and to each other can be produced, with the cutting strips overlapping or intersecting each other in the transition area between the cutting strips disposed parallelly to the blade tip and to the annulus. Preferably, the cutting strips produced parallelly to the blade tip may in this variant extend up to the highest point of the annulus, so that cutting strips extending parallelly to the annulus are produced only close to the latter.

The present invention is more fully described in light of the accompanying drawings, showing a preferred embodiment. In the drawings,

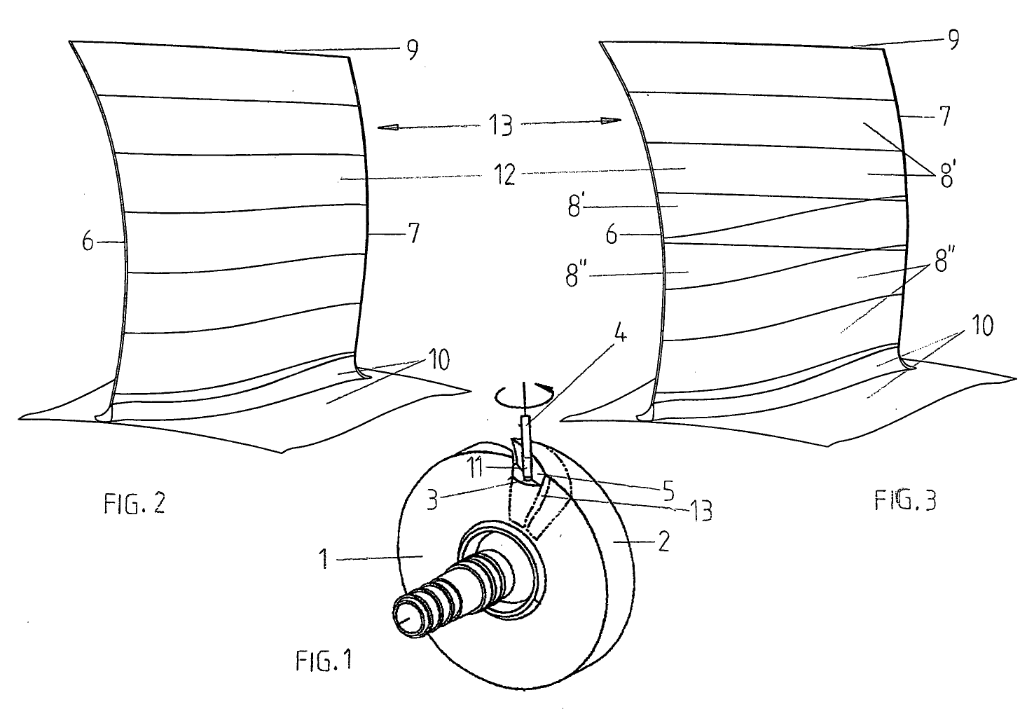

FIG. 1 shows a disk blank during rough milling of a first channel and finish milling of a blade pressure side by flank milling using a shank-type cutter,

FIG. 2 shows a blisk blade produced as per a first variant with cutting strips overlapping in a fan-like manner, and

FIG. 3 shows a blisk blade milled as per a second variant with parallel cutting strips.

As shown in FIG. 1, a channel 5 is first machined into a disk blank 1 by rough milling, starting at the peripheral surface 2 of the latter, using the semi-spherical cutting head 3 of a shank-type cutter 4 which is here only schematically shown. Subsequently the side faces of the channel 5, i.e. the pressure side and the suction side of a blisk blade 13, are finish-machined (finish milled) by five-axis flank milling using the cutting edge 11 provided at a semi-spherical cutting head 3 of the shank-type cutter 4. In the process, a multitude of constant-width cutting strips 8 traversing the pressure and the suction side, i.e. extending between the blade leading edge 6 and the blade trailing edge 7, is milled.

FIG. 2 shows, in a view towards the convex suction side 12, a three-dimensional blisk blade 13 produced upon milling of two adjacent channels 5 whose blade leading edge 6 and blade trailing edge 7 extending between the blade tip 9 and the annulus 10 or the transition surface to the annulus 10, respectively, have different lengths. Nevertheless, the cutting strips 8 are oriented from the blade leading edge 6 to the blade trailing edge 7 in the direction of the flow passing the blades in operation of the blisk in that the cutting strips 8 are produced in such a manner during finish milling that, at the blade tip 9 and at the annulus 10, they extend parallel to these and, otherwise, overlap each other from the longer blade leading edge 6 to the shorter blade trailing edge 7. This means that the cutting strips 8 are arranged in a fan-like manner and correspondingly, while being parallelly arranged each at the blade tip 9 and the annulus 10, transit in the intermediate zone from the inclination at the blade tip 9 to the differently oriented inclination at the annulus 10. Owing to the rounded transition from the cutting edge 11 of the shank-type cutter 4 into a semi-spherical cutter head 3, a smooth transition between adjacent cuttings strips 8 is produced. The cutting strips 8 on the pressure side, which is not shown here, are produced in the same manner. Accordingly, the course of the cutting strips on both blade sides agrees with the direction of flow, thereby reducing aerodynamic losses. Moreover, the aerodynamic losses are still further reduced in that the steps usually existing between adjacent cutting strips are machined over in the overlapping flank milling process, thereby considerably reducing their size. At the same time, the effort for subsequent polishing of the blade surfaces is reduced.

According to yet another variant shown FIG. 3 the cutting strips 8′, which are produced with constant width, are arranged, over a certain part of the blade length, parallelly to the course of the blade tip 9 and without overlap from the blade leading edge 6 to the blade trailing edge 7, and the further cutting strips 8″ in the remaining blade part are arranged parallelly to the annulus 10. At the interface of both areas, a cutting strip 8′ and another one 8″ arranged parallel to the blade tip 9 and to the annulus 10 intersect each other. The cutting strips 8′ extending parallelly to the blade tip 9 can in this form be produced up to the highest point on the annulus 10, while the cutting strips 8″ are produced parallelly to the annulus 10 only in the small, remaining area. Also in this case, the flow direction and the orientation of the cutting strips 8′, 8″ essentially agree with each other, enabling the aerodynamic losses on the pressure and suction sides of the blisk blades 13 to be minimized.

### LIST OF REFERENCE NUMERALS

1 Disk blank
2 Peripheral surface
3 Cutting head
4 Shank-type cutter
5 Channel
6 Blade leading edge
7 Blade trailing edge
8 Cutting strips, overlapping
   8′, 8″ Cutting strips, parallel
9 Blade tip
10 Annulus, transition area
11 Cutting edge
12 Suction side
13 Blisk blade

What is claimed is:

1. A method for milling a blisk for a gas-turbine engine, comprising:
pre-shaping a multitude of integrally provided three-dimensional blisk blades at a periphery of a disk blank by rough milling;
subsequently finish milling pressure and suction sides of the blades, as well as an annulus of the blisk;
wherein the finish milling of the pressure and suction sides is accomplished by flank milling with equally wide cutting strips produced by a cutting edge of a cutter, with cutting strips adjacent at least one of a blade tip and the annulus oriented to align with a direction of flow between the blisk blades.

2. The method of claim 1, wherein the cutting strips between a blade leading and a blade trailing edge overlap each other in a fan-like manner, with cutting strips at a blade tip and at the annulus extending parallelly to same respectively, and with cutting strips between them gradually transiting from an inclination of a cutting strip at the blade tip to an inclination of a cutting strip at the annulus; at least one of the overlapping cutting strips smoothly machining over a step formed by a preceding strip.

3. The method of claim 1, wherein cutting strips are produced starting at the blade tip and starting at the annulus with the cutting strips at the blade tip and the annulus respectively extending parallel to same, and with inner cutting strips overlapping each other at a transition between differently inclined cutting strip areas at the blade tip and the annulus.

4. The method of claim 3, wherein the cutting strips extending parallelly to the blade tip are produced up to a highest point on the annulus, while cutting strips extending parallelly to the annulus are produced only in a remaining area.

5. The method of claim 4, wherein the cutter is a shank-type cutter, having a straight cutting edge provided for producing the cutting strips and an adjoining semi-spherical cutting head.

6. The method of claim 1, wherein the cutter is a shank-type cutter, having a straight cutting edge provided for producing the cutting strips and an adjoining semi-spherical cutting head.

7. The method of claim 2, wherein the cutter is a shank-type cutter, having a straight cutting edge provided for producing the cutting strips and an adjoining semi-spherical cutting head.

8. The method of claim 3, wherein the cutter is a shank-type cutter, having a straight cutting edge provided for producing the cutting strips and an adjoining semi-spherical cutting head.
